(19) United States
(12) Patent Application Publication
(10) Pub. No.: US 2005/0035600 A1
(43) Pub. Date: Feb. 17, 2005

(54) Inductive voltage generator

(76) Inventors: Andre Albsmeier, Munchen (DE); Wolf-Eckhart Bulst, Munchen (DE); Max Guntersdorfer, Grafing (DE); Klaus Pistor, Linden (DE); Frank Schmidt, Poering (DE); Oliver Sczesny, Aschheim (DE)

Correspondence Address: COHEN, PONTANI, LIEBERMAN & PAVANE, 551 FIFTH AVENUE, SUITE 1210, NEW YORK, NY, 10176, US

(21) Appl. No.: 10/478,028

(22) PCT Filed: May 22, 2002
(86) PCT No.: PCT/DE02/01847

(30) Foreign Application Priority Data
May 22, 2001 (DE) 10125059.2

(51) Int. Cl. H02P 9/04

(52) U.S. Cl. 290/1 E

(57) ABSTRACT

A voltage generator (1) for conversion of non-electrical primary energy (PE) to a voltage signal (USIG, USIG′) by means of induction. The voltage generator (1) has at least one mechanical energy store (2) for holding the primary energy (PE), and which has at least one changeover point (P). At least one induction system (3) is provided which can be coupled to the mechanical energy store (2), with the mechanical energy store (2) carrying out a movement on reaching the at least one changeover point (P) by means of which movement a voltage signal (USIG, USIG′) can be induced in the induction system (3).

The invention relates to an inductive voltage generator for conversion of non-electrical primary energy to a voltage signal by means of induction, which is suitable in particular for sensors and signaling systems without batteries, to a switch, to a sensor system and to a method for voltage generation based on the induction principle.

WO 98/36395 discloses an arrangement for generation of coded radio-frequency signals, in which a transducer for conversion of non-electrical primary energy to low-frequency electrical energy is provided, inter alia by means of electrodynamic conversion of oscillation/acceleration change energy. A spring which can be moved beyond a dead point and which acts suddenly on the transducer when loaded beyond the dead point, for generating a piezo-voltage is described.

Until now, a voltage generator having a piezoelectric element and a small dynamo has essentially been known for inductive conversion of mechanical primary energy. The dynamo solution comprises an arrangement with an induction coil having an iron core and a permanent magnet which oscillates in front of the iron core; this arrangement is comparatively complex and has a comparatively large volume.

The object of the present invention is to provide a compact capability for high-efficiency inductive voltage generation, and which is particularly suitable for sensors and signaling systems without batteries.

This object is achieved by means of a voltage generator as claimed in claim 1, by a switch as claimed in claim 4, by a sensor system as claimed in claim 5, and by a method as claimed in claim 6. Advantageous refinements can be found in the dependent claims.

For this purpose, the voltage generator has at least one mechanical energy store for holding the non-electrical primary energy, and at least one induction system which can be coupled to it.

The primary energy may, for example, be mechanical process energy (for example (finger) pressure, tension or vibration) and/or environmental energy (for example a temperature difference), or a combination of both. The mechanical process energy may, for example, be provided by a manual operation, for example of a switch. The thermal environmental energy may, for example, be introduced into the mechanical energy store via an element with a temperature-dependent expansion behavior, for example a bimetallic switch or a so-called memory element.

The mechanical energy store is any system which can store energy essentially reversibly by changing mechanical characteristic variables (for example pressure, tension, potential energy, deformation etc.). For example, a spring (tension spring, bending element, etc.) can store expansion energy or a weight can store potential energy and, for example, can emit it again via the movement of a plunger. A pneumatic spring, which can emit pressure energy via a plunger, may, for example, also be regarded as a mechanical energy store.

The induction system is designed such that it is suitable for emitting an induction voltage, and typically has at least one induction coil, possibly with a magnetic core, which generally contains iron.

The induction system is coupled to the mechanical energy store such that the induction voltage can be induced by a movement of the mechanical energy store in the induction system; the mechanical energy that is emitted is thus converted to a voltage signal, by means of induction from the induction system. By way of example, the mechanical energy store for this purpose contains a magnet, preferably a permanent magnet, which, after reaching the changeover point, is moved by the mechanical energy that is released such that it causes a change over time in the magnetic flux Φ in the area of the induction system. The mechanical energy store may thus also be used as a transformer for non-mechanical primary energy to mechanical motion energy.

The voltage generator has at least one changeover point, on reaching which at least some of the mechanically stored energy is converted into movement for inductive generation of the voltage signal. The changeover point thus analogously corresponds to a threshold value of the stored mechanical energy. Before reaching the changeover point, the primary energy which is supplied to the mechanical energy store is essentially only stored in it.

The changeover point may be dependent on the environment and on the induction system. It is advantageous for there to be more than one changeover point and/or for it to be possible to reach the respective changeover point from both sides, because this makes it possible to adjust the voltage generation in a flexible manner. It is also advantageous for the movement to take place as suddenly as possible. For example, when using a spring as the energy store, the changeover point can be reached both by means of a pressure load and by means of a tension load, in which case the level of the changeover point may differ in the two operating directions.

The use of the mechanical energy store with a changeover point results in the advantage that the profile of the magnetic field change, and hence of the induction voltage, does not depend on the time effect of the primary energy. Furthermore, the magnitude of the converted energy is essentially constant.

It is preferable for the primary energy to be supplied to the mechanical energy store by means of a control element, for example a switch. The control element may also be part of the mechanical energy store.

The voltage generator is illustrated schematically in more detail in the following exemplary embodiments.

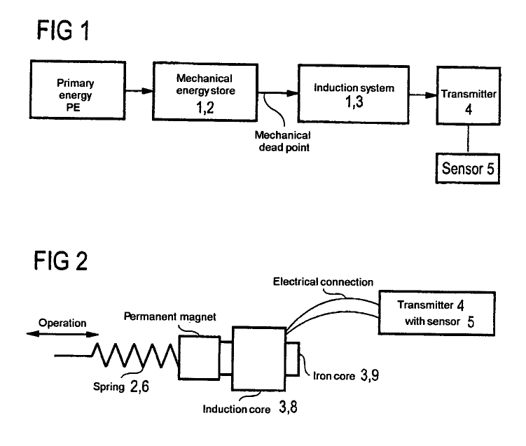

FIG. 1 shows the principle of voltage generation,

FIG. 2 shows a sensor system which contains the inductive voltage generator for energy supply,

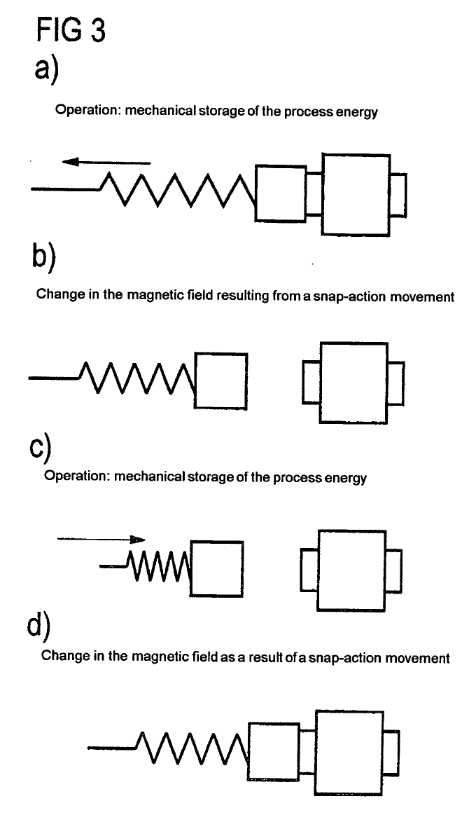

FIG. 3 shows various positions during operation of the voltage generator.

FIG. 1 shows an outline circuit diagram for voltage generation.

Non-electrical primary energy PE which is available from the environment (for example a temperature difference AT) or from a process (for example finger pressure) is fed into the mechanical energy store 2 as part of the voltage generator 1. After reaching the changeover point P, its mechanical energy is introduced via a movement into the induction system 3, which is likewise a part of the voltage generator 1, where it is used to generate a voltage signal USIG. The voltage signal USIG is then available to a load, in this case, a transmitter 4 with a sensor 5 connected to it. The voltage generator is particularly suitable for loads without batteries, for example click sensors and radio remote-control switches. The transmitter 4 may, for example, be a radio remote-control switch, and may transmit transmission messages by radio IR etc.

FIG. 2 shows a side view of one preferred embodiment of a voltage generator 1.

A spring 6 (which may also be preloaded) is used as the mechanical energy store 2 in this figure.

The right-hand end of the spring 6 is attached to a permanent magnet 7. In this position, the permanent magnet 7 rests on an iron core 9 which is surrounded by an induction coil 8; the induction coil 8 and iron core 9 are part of the induction system 3. Instead of the mechanical tension spring 6, a rotary spring, a weight or a pneumatic spring may also be used, for example, as the mechanical energy store 2.

A load in the form of a transmitter 4, which comprises a sensor 5 and a radio-frequency transmission stage, is connected to the induction coil 8 via an electrical connection 10.

The left-hand end of the spring 6 is connected to an operating unit for operation of the spring 6 (not illustrated here), for example to one end of a rocker switch.

The figure elements a) to d) of FIG. 3 show an operating and resetting process for the apparatus shown in FIG. 2.

The left-hand end of the spring 6 in FIG. 3a is loaded in the direction of the arrow. As the tensile stress increases, more mechanical energy is stored in the spring 6. In this figure, the stress in the spring 6 is not yet sufficient to release the magnetic adhesion of the permanent magnet 7 from the iron core 9.

In FIG. 3b, the tensile stress in the spring 6 has become sufficient to release the permanent magnet 7 from the iron core 9. The movement of the permanent magnet 7 produces a change over time in the magnetic flux Φ, as a result of which a voltage UISG is induced in the induction coil 8; the mechanically stored energy is thus converted to electrical energy.

The changeover point (“mechanical dead point”), at which separation takes place, is dependent only on the stress in the spring 6. The changeover point is advantageously also defined, for example, by the strength of the magnetic field itself.

In FIG. 3c, the spring 6 is now operated in the opposite direction. The speed at which the permanent magnet 7 approaches the iron core 9 is governed by the operating process and by the attraction force between the permanent magnet 7 and the iron core 9. As the interaction force increases, the speed of the permanent magnet 6 also increases. Its movement in the opposite direction likewise induces a voltage signal USIG′ in the induction coil. The movement direction of the mechanical energy store 2 can advantageously be determined in the load, for example by detection of the polarity of the voltage signals USIG, USIG′. It is thus possible to distinguish for example whether a switch is being switched on or being switched off.

FIG. 3d shows the arrangement in the rest position after returning to the initial position.

In the present exemplary embodiment, the permanent magnet 7 thus has two defined limit positions in which it is held in a stable state. Under the influence of the primary energy, the spring 6 stores mechanical energy until, on reaching at least one changeover point, the permanent magnet 7 snaps open to its other stable limit position, with the mechanical energy from the spring 6 being converted at least partially into the voltage signal USIG, USIG′.

This voltage generator may be physically very compact, operates with relatively high efficiency, is simple to manufacture and furthermore has the advantage of a mechanically defined switching point. Only a simple snap-action movement is required instead of a complex oscillating magnet movement.

The invention also relates to switches and sensor systems which have the voltage generator, for example click sensors, light switches etc., in particular switches and sensor systems without batteries, which can transmit and receive messages by radio. As exemplary embodiments for the voltage generator, reference should be made to WO 98/36395, in particular to the use of switches and sensors in a powerline communication (PLC) system, see, for example, Süddeutsche Zeitung [South German Daily Newspaper], No. 74 dated Mar. 29, 2001, page 27. The voltage generator is, of course, not restricted to these exemplary embodiments.

1. A voltage generator (1) for conversion of non-electrical primary energy (PE) to a voltage signal (USIG, USIG′) by means of induction, characterized in that the voltage generator (1) has at least
one mechanical energy store (2) for holding the primary energy (PE), and which has at least one changeover point (P),
at least one induction system (3) which can be coupled to the mechanical energy store (2),
with the mechanical energy store (2) carrying out a movement on reaching the at least one changeover point (P) by means of which movement a voltage signal (USIG, USIG′) can be induced in the induction system (3).

2. The voltage generator (1) as claimed in claim 1, in which the mechanical energy store (2) contains a spring (6) to which a magnet, in particular a permanent magnet (7) is attached.

3. The voltage generator (1) as claimed in claim 2, in which the induction system (3) has an induction coil (8) with a ferromagnetic core (9), in which the magnet can be placed on the ferroelectric core.

4. A switch, in particular for mechanical operation, having a voltage generator (1) as claimed in claim 1.

5. A sensor system, having a voltage generator (1) as claimed in claim 1, and having at least one sensor (5).

6. A method for inductive voltage generation, in which
primary energy (PE) is stored in a mechanical energy store (2) until at least one changeover point (P) is reached,
the mechanical energy store (2) is moved on reaching the changeover point (P) such that a voltage signal (USIG, USIG′) is generated in an induction system (3) which is coupled to the mechanical energy store (2).

7. The method as claimed in claim 6, in which the primary energy (PE) is stored in the mechanical energy store (2) by expansion or deformation of said mechanical energy store (2).

8. The method as claimed in claim 6, in which, on reaching the changeover point (P), a magnet, in particular a permanent magnet (7), is moved such that an induction voltage (USIG, USIG′) is generated by means of a change in a magnetic flux (Φ) in the area of an induction coil (8).
